(19) United States
(12) Patent Application Publication
(10) Pub. No.: US 2016/0249769 A1
(43) Pub. Date: Sep. 1, 2016

(54) Outdoor Grill Having An Infrared Burner and Improved Heat Reflection System

(71) Applicant: The Grill Company, LLC, Columbia, SC (US)

(72) Inventors: John Ducate, Columbia, SC (US); Tianzhi Wu, Jimei District (CN); Robin Ho, Kaohsiuing City (TW)

(73) Assignee: The Grill Company, LLC, Columbia, SC (US)

(21) Appl. No.: 15/049,549

(22) Filed: Feb. 22, 2016

Related U.S. Application Data
(60) Provisional application No. 62/121,106, filed on Feb. 26, 2015.

(51) Int. Cl. A47J 37/06

(52) U.S. Cl. CPC A47J 37/06

(57) ABSTRACT

The present invention comprises an outdoor grill having a burner box, a cooking surface disposed above the burner box an infrared heating element disposed within the burner box and a reflector that reflects heat waves emitted from the infrared heating element towards the cooking surface. The reflector includes a first end portion, a central portion and a second end portion. The lateral wings can include two angled plates that create a lateral wing ridge. The central portion can include two angled plates that create a central ridge that interconnects the later wings.

### BACKGROUND OF THE INVENTION

1) Field of the Invention

The present invention relates to a cooking grill including an outdoor grill utilizing infrared heating elements and a heat reflection system to maximize and evenly distribute the infrared and convection heat applied to a grilling surface.

2) Description of Related Art

While the use of infrared heaters in combination with one or more reflectors to cook food is generally known, the reflectors tend to be placed behind one or more burners and generally have a concave shape. The prior art fails to disclose a reflector that is located between two infrared heating elements that are disposed in an angled side wall of the grill's fire box so that they are generally directed towards the reflector. By placing a generally concave reflector behind the infrared burner, the heat that is reflected by the prior art reflectors converges towards a central point of the cooking surface rather than being dispersed along the entire cooking surface.

Further, the prior art fails to disclose the use of convection heat shields located above the infrared heating elements and reflector but below the cooking surface that capture some of the infrared heat produced by the burners so as to create convection heat along the entire grilling surface.

Accordingly, it is an object of the present invention to provide a grill having reflector that more evenly distributes heat along the entire cooking surface.

It is another object of the present invention to provide a grill that produces infrared heat and convection heat along the entire cooking surface.

### SUMMARY OF THE INVENTION

The above objectives are accomplished according to the present invention by providing an outdoor grill comprising a fire box located beneath a cooking surface; at least one infrared burner disposed in at least one side wall of said fire box, wherein the burner may be disposed at an angled relationship to the cooking surface located above the fire box; and a reflector disposed generally adjacent to said infrared burner and a bottom of said firebox so that heat emitted from said infrared burner is directed to said reflector and reflected towards said cooking surface. Wherein the reflector includes a central portion and two opposing end portions, where a first central plate is connected to a second central plate, thus creating a central ridge of the central portion of the reflector. The reflector further includes a first end plate connected to a second end plate to create a first end ridge of the first end portion of the reflector and a first end plate is connected to a second end plate to create a second end ridge of said second end portion of said reflector.

The invention can include a heat box carried by a frame; a pair of infrared heating elements disposed laterally along opposite sides of the heat box for projecting heat inward wherein the infrared heating elements are disposed at radiant angles between 10° and 60°; a reflector disposed between the infrared heating elements for reflecting heat generally upwards to a cooking surface carried by the frame wherein the reflecting plate includes a central ridge defined by two joining central plates; lateral wings included in the reflector plate each defined by of lateral plates; and, flanges attached to each lateral plate for supporting the reflector in the heat box; a set of heat shields carried by the heat box disposed above the reflector and configured to create convection heat along the cooking surface; and lateral supports attached at each end of the heat shields for supporting the heat shield in the heat box.

Concave openings can be defined in the reflector plate configured to allow fluids to pass through the reflector plate. Lateral support openings can be defined in the lateral support of the heat shields. Finger openings can be defined in the reflector. A reflector central cross-section can be included that has a generally a “V” shape. An inner cross-section having a base width larger than a base width of a reflector outer cross-section can be included in the reflector. A flange angle of between about 100° and 170° can be included in the reflector. The infrared heating elements, the reflector, and the heat shields can be configured and arranged to have heat generated from the infrared heating elements reflected generally horizontally and provide convection heat at the cooking surface. A central pitch can be is smaller than a lateral wing pitch. A ridge angle can be greater than 0° and less than about 70°.

A set of concave openings can be defined in a central portion of the reflector plate and arranged in a central row. A set of concave opening defined in the lateral wings of the reflector plate can be arranged in a pair lateral rows on each lateral wing. The central row and the lateral rows can be divergent.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows an exploded view of an embodiment of the present invention.

FIG. 2 shows a top plan view of an embodiment of the present invention.

FIG. 3 shows a cross-sectional view of an embodiment of the present invention.

FIG. 4 shows a top plan view of an embodiment of the convection heat shields.

FIG. 5 shows a top plan view of an embodiment of the reflector inside of the burner box of the present invention.

FIG. 6 shows a top plan view of an embodiment of the reflector.

FIG. 7 shows a side elevation view of an embodiment of the reflector.

FIG. 8 shows a perspective view of an embodiment of the reflector.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

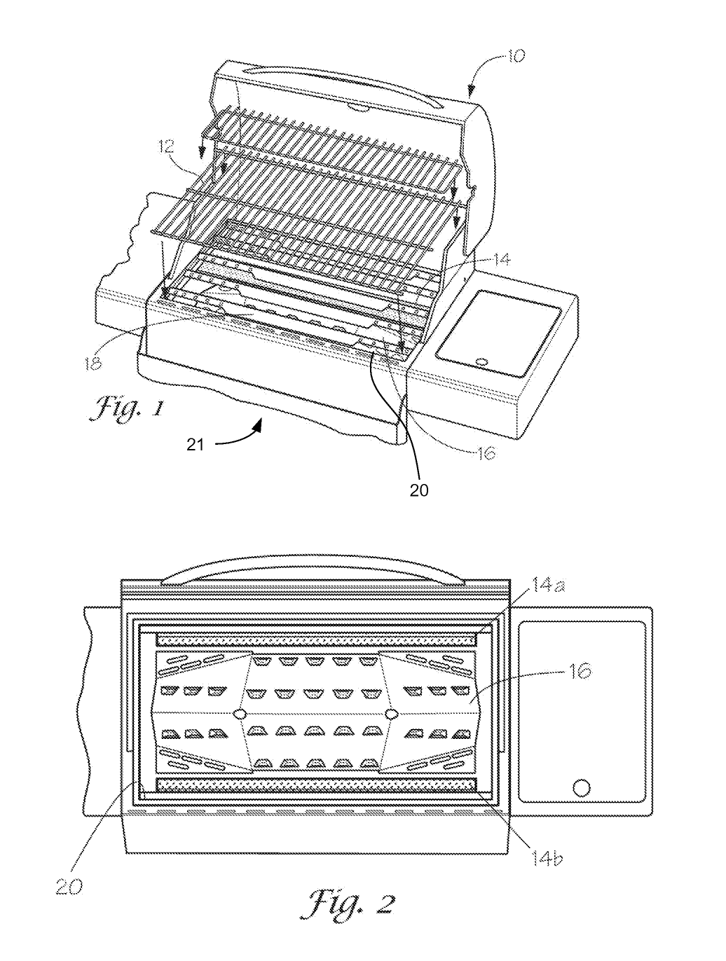

FIG. 1 shows an exploded view of an outdoor grill generally shown as 10, which has a cooking surface 12, at least one infrared gas burner 14 a reflector 16, at least one convection heat shield 18 that can be contained in or carried by a heat box 20 that is carried by a frame 21.

As can be seen in FIG. 2, in one embodiment of the invention, the grill includes two infrared heating elements 14a and 14b that are disposed in opposing side walls of the fire box 20. In one embodiment a ceramic infrared burner is used. In other embodiments, however, any type of infrared heat source generally known in the art could be used. In the shown embodiment, the grill further includes a reflector 16 that is disposed between the two infrared heating elements 14a and 14b. The reflector is designed to reflect the infrared heat waves emitted from the infrared heating elements evenly across the entire cooking surface. The reflector can be made aluminum, stainless steel or any other material that has the capability of reflecting heat waves towards the cooking surface.

Referring now to FIG. 3, a cross section view of the burner box 20 and various grill components can be seen. In one embodiment of the invention, the grill includes two infrared burners or infrared heating elements 14a and 14b that can be disposed laterally at opposite sides walls of the heat box 20. The infrared heating elements can be disposed at radiant angles between 0° and 90°. In one embodiment, the radiant angles are between about 10° and 60°. The radiant angles are defined between a horizontal plane 31 that can be generally parallel to the bottom 33 of the heat box. The radiant angles 35a and 35b can be defined by the angle between the horizontal plane 31 and the axis of the infrared heating elements 37a and 37b.

In alternate embodiments, however, the infrared heating elements could be disposed in the front and back walls of the fire box. In one embodiment a ceramic infrared burner is used. In other embodiments, however, any type of infrared heat source generally could be used. In the shown embodiment, the infrared ceramic burners 14a and 14b are disposed in opposing side walls 21a and 21b such that the burners are angled 10 degrees from a vertical position so that the surface of the infrared heating elements are slightly angled upwards towards the cooking surface 12. In alternate embodiments, however, the infrared heating elements 14 could be angled between 0 and 90 degrees from a vertical position.

In the shown embodiment, the grill further includes a reflector 16 having a first central plate 22 that is angled towards a second central plate 24 such that a central ridge 26 is created. In one embodiment, the central ridge 26 is generally parallel to the cooking surface 12. In other embodiments, however, the central ridge may not be generally parallel to the cooking surface. In the shown embodiment, the central ridge 26 runs generally parallel to the front and back of the grill. In alternate embodiments, however, the central ridge 26 could run generally perpendicular to the front and back of the grill. Regardless of which direction the ridge 26 extends, it typically extends in a generally parallel manner to the infrared heating elements. For example, when the reflector 16 is positioned in the burner box 20 such that the central ridge 26 extends generally perpendicular to the front and back walls of the burner box, the infrared heating elements 14a and 14b would typically be disposed in the opposing side walls of the burner box rather than being disposed in the front and back side walls of the burner box as is shown 2-3 and 5. However, the central ridge 26 could run in an angled relationship or even perpendicular to the infrared heating elements

In at least one embodiment, the reflector 16 contains a plurality of concave openings 28 that are disposed along the surface of the first and second central plates 22 and 24 of the reflector. These openings 28 allow any grease drippings or other liquids from the food being cooked to pass through the reflector and into a grease trap (not shown) that is disposed beneath the reflector.

In the shown embodiment, the reflector 16 is centered between the two burners 14a and 14b. This placement and shape of the reflector place allows the reflector 16 to maximize the reflection of heat waves 30 emitted from the burners 14 towards the cooking surface 12. Thus, the reflector evenly disperses the heat waves 30 along the entire cooking surface 12. In one embodiment, the central ridge 26 of the reflector does not extend past the top of the infrared heating elements 14a and 14b. As can be seen, the height of the reflector allows the heat waves 30 emitted from the infrared heating elements 14a and 14b to pass over the central ridge 26 more evenly distribute the infrared heat waves 30 emitted from the infrared heating elements. In alternate embodiments, however, the central ridge 26 of the reflector 16 may have a height that extends above the top of the burners. In this arrangement, it is easier to keep a hot side of the cooking surface 12 and a cool side of the cooking surface as the heat waves 30 are not allowed to pass over the reflector 16 so that all of the heat waves 30 are reflected towards one side of the cooking surface.

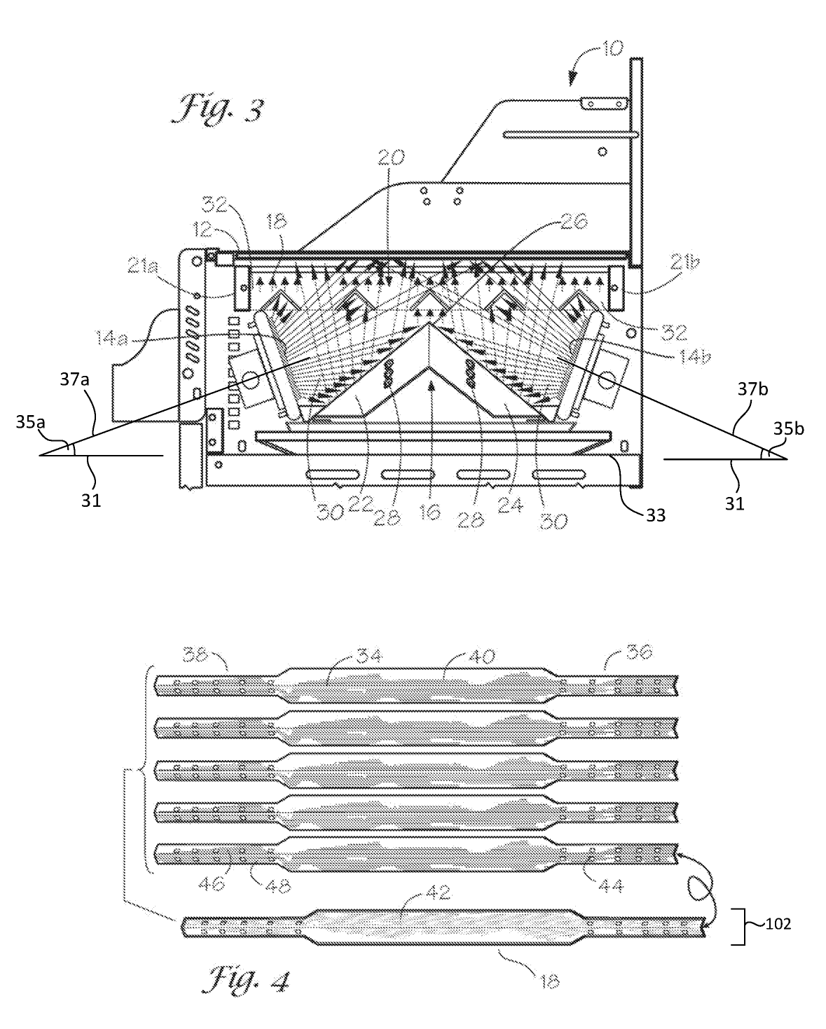

As can be seen in FIGS. 3 and 4, the present invention also includes convection heat shields 18. In the shown embodiment, the convection heat shields 18 are evenly spaced within the fire box 20 beneath the cooking surface 12. In at least one embodiment the convection heat shields 18 extend longitudinally along the length of the fire box 20 and parallel to the infrared heating elements 14. In alternate embodiments, the heat shields could extend perpendicular to the infrared heating elements and/or along the width of the fire box. In either arrangement, at least a portion of the infrared heating elements 14a and 14b can be protected from food drippings by the placement of one or more convection heat shields 18 above the burners, thus diverting the food drippings away from the infrared heating elements 14a and 14b. In one embodiment, the convection heat shields may be integral with fire box. In other embodiments, the convection heat shields may be removable. The convection heat shields are designed to capture a portion of the heat waves 30 emitted from the infrared burner and/or reflected off of the reflector 16. These heat waves 30 heat the convection heat shields, causing them to radiate convection heat waves 32, thus, causing the heat waves 30 and 32 to be more evenly distributed along the cooking surface. In the shown embodiment, these convection heat shields have two angled surfaces, creating a ridge. In alternate embodiments, the convection heat shields may have any shape generally known, such as a radiused surface, or could be flat. In one embodiment, the convection heat shields 18 are evenly spaced along the entire cooking surface. However, the convection heat shields 18 could have any suitable range of widths that are less than the width of the cooking surface 12.

As can be seen in FIG. 4, in one embodiment, the heat shields 18 are included. Generally, heat shields can: prevent flare-ups, vaporize some of the liquid, including grease, that drips off the cooking food and shed any excess into a drip pan below the heat shields. Heat shields also can promote even heat distribution, protect heating source and prevent debris from clogging the heat source. Heat shields can also enhance taste by vaporizing grease and other liquids adding aroma and flavor of grilled foods.

The heat shield have a central portion 34 and two opposing lateral supports 36 and 38. The central portion is made of two solid side panels, 40 and 42 while the lateral supports 36 and 38 have lateral openings 44 disposed in the angled side panels 46 and 48. Moreover, the angled side panels 40 and 42 that create the central portion 34 of the convection heat shield 18 are longer and extend past the angled side panels 46 and 48 of the lateral support. In this embodiment, more heat waves 30 are captured by the central portion 34 than by the lateral supports 36 and 36. Moreover, the lateral openings 44 allow more heat to easily reach the cooking surface than the heat is able to do in the central portion 34 of the convection heat shield 18. Thus, more heat is distributed to the sides of the cooking surface, which in prior art grills, tend to be cooler than the middle of the cooking surface. Thus, the infrared heat is evenly distribute along the entire cooking surface.

The infrared heating elements, the reflector and the heat shields are configured and arranged to have heat generated from the infrared heating elements reflected generally horizontally and provide convection heat at the cooking surface.

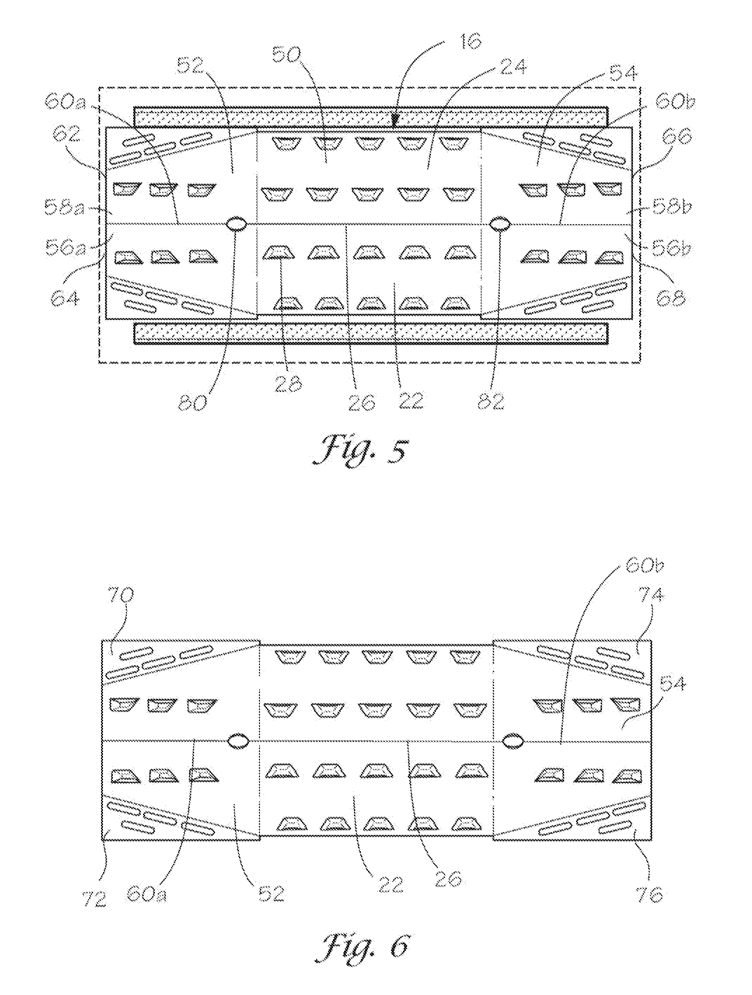

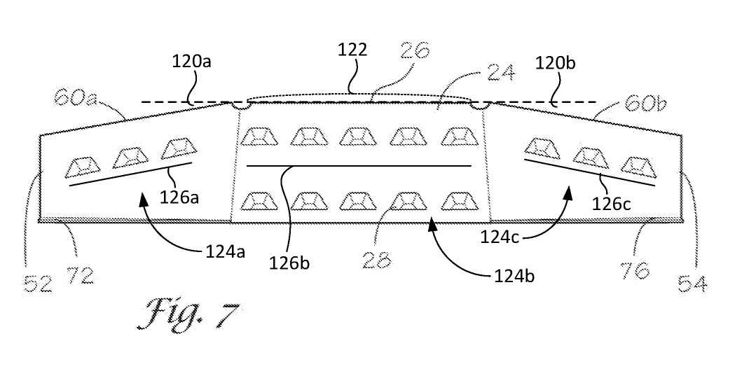

Referring now to FIGS. 5-8, the reflector 16 can be more clearly seen. In the shown embodiment, the reflector has a central portion 50, a left end portion 52 and a right end portion 54 that mirrors the first end portion. However, in some instances such as the embodiment where the central ridge 26 extends generally perpendicular to the front and rear of the grill, the left and right end portions may be more aptly referred to as the front and rear end portions. The central portion 50 is defined by a first central plate 22 and a second central plate 24 that are angled towards one another so that the tops of the plates join together to form a central ridge 26. The left and right end portions 52 and 54 are defined by a first angled end plate 56a and 56b and a second angled end plate 58a and 58b. These angled end plates joint together to create a left and a right end ridge 60a and 60b or lateral wing ridges. Similarly, the first end plate 56a of the left end portion 52 is attached to or integral with a first end edge of the first central plate 24. The first end plate 56b of the right end portion 54 is attached to or integral with a second opposing end edge of the first central plate 24. The second end plate 58a of the left end portion 52 is attached to or integral with the a first end edge of the second central plate 24. The second end plate 58b of the right end portion 54 is attached to or integral with the a second opposing end edge of the second central plate 24.

Accordingly, the left end ridge 60a is attached to or integral with a first end of the central ridge 26. The right end ridge 60b is also attached to or integral with the central ridge 26 at a second opposing end of the central ridge 26. In one embodiment, the left and right end ridges 60a and 60b are angled in relation to the central ridge 26 such that the end ridges 60a and 60b slope downwardly towards the bottom of the burner box 20 and in opposite directions from one another such that the left end ridge 60a slopes downwardly towards the left side of the burner box and the right end ridge 60b slopes downwardly towards the right side of the burner box. In alternate embodiments, the end ridges could be parallel with the central ridge 26 so as to simply extend the overall length of the central ridge or even angle upwardly from the central ridge toward the cooking surface. In alternate embodiments, the left and right end ridges could be parallel to one another, extend with in the same axis, slope at the same angle or slope at different angles.

The lateral wing ridges 60a and 60b can define ridge angles 120a and 120b (FIG. 7) in relation to the central ridge 26. In one embodiment, the ridge angles are greater than 0° and less than about 70°. In one embodiment, the central ridge can include a curvature 122 between the end of the central ridge. The left wing concave openings 124a can be arranged along a left lateral row 126a. The right wing concave openings 124c can be arranged along a right lateral row 126c. The central concave openings 124b can be arranged along a right lateral row 126b. The left lateral row, right lateral rows and central row can be divergent so that if extended, these rows would intersect.

In the shown embodiment, the left end plates 56a and 58a and the right end plates 56b and 58b are in an angled relation to the central plates 22 and 24. The left end plates are angled such that a first end edge 62 and 64 of the left end plates that are not attached to the central portion 50 extend closer towards the middle of the burner box than the opposing end edges that are attached to or integral with the central portion. The right end plates 56b and 58b are angled in an opposite direction from the left end plates 56a and 56b such that a first end edge 66 and 68 of the right end plates that are not attached to the central portion 50 extend closer towards the middle of the burner box than the opposing end edges that are attached to or integral with the central portion 50. In alternate embodiments, however, the left end plates and the right end plates may extend within the same axis as the central plates.

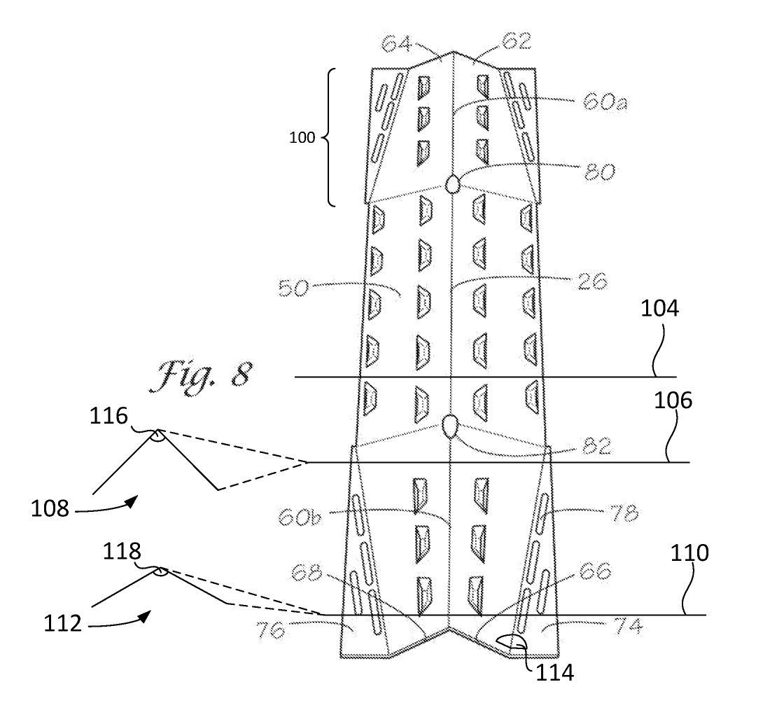

In the shown embodiment, the left end portion includes two opposing flanges 72 and 74 that generally have a triangular shape. Similarly, the right end portion includes two opposing flanges 74 and 76 that have a generally triangular shape. These flanges extend outwardly from the end plates 56a-b and 58a-b such that the flanges are generally parallel to both the cooking surface 12 and the bottom of the burner box. These flanges provide stability to the reflector 16 and help ensure that the reflector is centered between the two infrared heating elements 14a-b. In at least one embodiment, each of the flanges 70, 72, 74, and 76 have at least one opening 78 disposed therein to allow grease to drip through to a grease trap (not shown). A flange 114 (FIG. 8) angle can be defined between one of the lateral wings plates and the flanges. In one embodiment, the flange angle is between about 100° and 170°.

The reflector can include lateral wings with one end shown as 100 in FIG. 8. The lateral wings can be defined by the end plates and flanges. A reflector central cross-section 104 can be generally a “V” in one embodiment. The reflector can include an inner cross-section having a base. The base is the distance between the distal opposite the vertices of the angle of the cross-section shown as 108. The inner cross-section base can be larger an outer cross-section 110 base 112. The central pitch 116 of the reflector can be smaller than the later wing pitch 118 in one embodiment. The area defined by the central cross-section can be greater than the area defined by the inner cross-section which can both be greater than the area defined by the reflector outer cross-section.

In the shown embodiment, the reflector further includes two finger openings 80 and 82 disposed in the central ridge 26 to allow easy placement of the reflector in the burner box 20 and removal therefrom. In alternate embodiments, the finger openings 80 and 82 could be placed anywhere on the reflector that would allow a user to lift the reflector from within the burner box.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

What is claimed is:

1. A cooking grill comprising:
a heat box carried by a frame;
a pair of infrared heating elements disposed laterally along opposite sides of the heat box for projecting heat inward wherein the infrared heating elements are disposed at radiant angles between 10° and 60°;
a reflector disposed between the infrared heating elements for reflecting heat generally upwards to a cooking surface carried by the frame wherein the reflecting plate includes a central ridge defined by two joining central plates;
lateral wings included in the reflector plate each defined by of lateral plates; and,
flanges attached to each lateral plate for supporting the reflector in the heat box;
a set of heat shields carried by the heat box disposed above the reflector and configured to create convection heat along the cooking surface; and
lateral supports attached at each end of the heat shields for supporting the heat shield in the heat box.

2. The cooking grill of claim 1 including concave openings defined in the reflector plate configured to allow fluids to pass through the reflector plate.

3. The cooking grill of claim 1 including lateral support openings defined in the lateral support of the heat shields.

4. The cooking grill of claim 1 including finger openings defined in the reflector.

5. The cooking grill of claim 1 including a reflector central cross-section that is generally a “V” shape.

6. The cooking grill of claim 1 including a reflector inner cross-section having a base width larger than a base width of a reflector outer cross-section.

7. The cooking grill of claim 1 including a flange angle of between about 100° and 170°.

8. The cooking grill of claim 1 wherein the infrared heating elements, the reflector and the heat shields are configured and arranged to have heat generated from the infrared heating elements reflected generally horizontally and provide convection heat at the cooking surface.

9. The cooking grill of claim 1 where a central pitch is smaller than a lateral wing pitch.

10. The cooking grill of claim 1 including a ridge angle greater than 0° and less than about 70°.

11. A cooking grill comprising:
a heat box carried by a frame;
a pair of infrared heating elements disposed laterally along opposite sides of the heat box for projecting heat inward;
a reflective plate disposed between the infrared heating elements carried by the frame wherein the reflecting plate includes central pitch between about 10° and 90° configured to and arranged with the infrared heating elements to reflect heat generally upwards to a cooking surface; and,
a set of heat shields carried by the heat box disposed above the reflector each having a central width configured to create convection heat along the cooking surface and having lateral supports attached at each end.

12. The cooking grill of claim 11 including concave openings defined in the reflector plate configured to allow some dripping fluids to pass through the reflector plate and some dripping fluid to be vaporized.

13. The cooking grill of claim 11 where a central pitch is smaller than a lateral wing pitch.

14. The cooking grill of claim 11 including a ridge angle greater than 0° and less than about 70°.

15. The cooking grill of claim 11 including flanges attached to each lateral plate for supporting the reflector in the heat box.

16. The cook grill of claim 15 including a flange angle of between about 100° and 170°.

17. A cooking grill comprising:
a heat box carried by a frame;
a cooking surface carried by the frame;
a pair of infrared heating elements disposed laterally along opposite sides of the heat box for projecting heat inward having radiant angles between 10° and 60°;
a reflective plate disposed between the infrared heating elements carried by the frame having lateral wings and a ridge angle greater than 0° and less than about 70°;
a set of heat shields carried by the heat box disposed above the reflector; and,
wherein the infrared heating elements, the reflector and the heat shields are configured and arranged to provide for heat generated from the infrared heating elements to be reflector generally horizontally and provide convection heat at the cooking surface.

18. The cooking grill of claim 17 wherein a reflector central cross-section has an area greater than a reflector inner cross-section which is greater than a reflector outer cross-section.

19. The cooking grill of claim 17 including a central ridge included in the reflector have a curvature.

20. The cooing grill of claim 17 including:
a set of concave openings defined in a central portion of the reflector plate arranged in a central row;
a set of concave opening defined in the lateral wings of the reflector plate arranged in a pair lateral rows on each lateral wing; and,
wherein the central row and the lateral rows are divergent.
